(19) United States
(12) Patent Application Publication
(10) Pub. No.: US 2013/0202190 A1
(43) Pub. Date: Aug. 8, 2013

(54) IMAGE PROCESSING APPARATUS AND IMAGE PROCESSING METHOD

(71) Applicant: Sheng-Chun Niu, Tainan City (TW)

(72) Inventor: Sheng-Chun Niu, Tainan City (TW)

(21) Appl. No.: 13/364,338

(22) Filed: Feb. 2, 2012

(51) Int. Cl. G06K 9/00

(52) U.S. Cl. 382/154

(57) ABSTRACT

An image processing apparatus includes an image detector and a controller. The image detector is utilized for receiving a surrounding image, and analyzing the surrounding image to determine a user's position. The controller is coupled to the image detector, and is utilized for receiving a stereo image, and modifying the stereo image to generate a modified stereo image by at least rotating the stereo image according to the user's position.

### BACKGROUND OF THE INVENTION

1. Field of the Invention

The present invention relates to an image processing apparatus, and more particularly, to an image processing apparatus that shows stereo images.

2. Description of the Prior Art

When a user is watching a 3D video but not sitting directly in front of the display, inappropriate depth information of the 3D video perceived by the user may lessen the enjoyment of the viewing experience. Furthermore, a performance of the 3D video may be influenced by environmental factors such as external light sources. Finding a solution to the above problems is essential for ensuring the quality of the user's 3D viewing experience.

### SUMMARY OF THE INVENTION

It is therefore an objective of the present invention to provide an image processing apparatus and associated method to solve the above-mentioned problems.

According to one embodiment of the present invention, an image processing apparatus comprises an image detector and a controller. The image detector is utilized for receiving a surrounding image, and analyzing the surrounding image to determine a user's position. The controller is coupled to the image detector, and is utilized for receiving a stereo image, and modifying the stereo image to generate a modified stereo image by at least rotating the stereo image according to the user's position.

According to another embodiment of the present invention, an image processing method comprises: receiving a surrounding image, and analyzing the surrounding image to determine a user's position; and receiving a stereo image, and modifying the stereo image to generate a modified stereo image by at least rotating the stereo image according to the user's position.

According to another embodiment of the present invention, an image processing apparatus comprises at least one light source detector and a controller. The light source detector is utilized for receiving a measuring result from at least one light sensor, and determining a position of a light source according to the measuring result. The controller is coupled to the image detector, and is utilized for receiving a stereo image and modifying the stereo image to generate a modified stereo image according to the position of the light source.

According to another embodiment of the present invention, an image processing method comprises: receiving a measuring result from at least one light sensor, and determining a position of a light source according to the measuring result; and receiving a stereo image and modifying the stereo image to generate a modified stereo image according to the position of the light source.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an image processing apparatus according to one embodiment of the present invention.

FIG. 2 is a flowchart of an image processing method according to one embodiment of the present invention.

FIG. 3 shows respective positions of a user and a light source.

FIG. 4 is a diagram illustrating an image processing apparatus according to another embodiment of the present invention.

FIG. 5 is a flowchart of an image processing method according to another embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ” The terms “couple” and “couples” are intended to mean either an indirect or a direct electrical connection. Thus, if a first device couples to a second device, that connection may be through a direct electrical connection, or through an indirect electrical connection via other devices and connections.

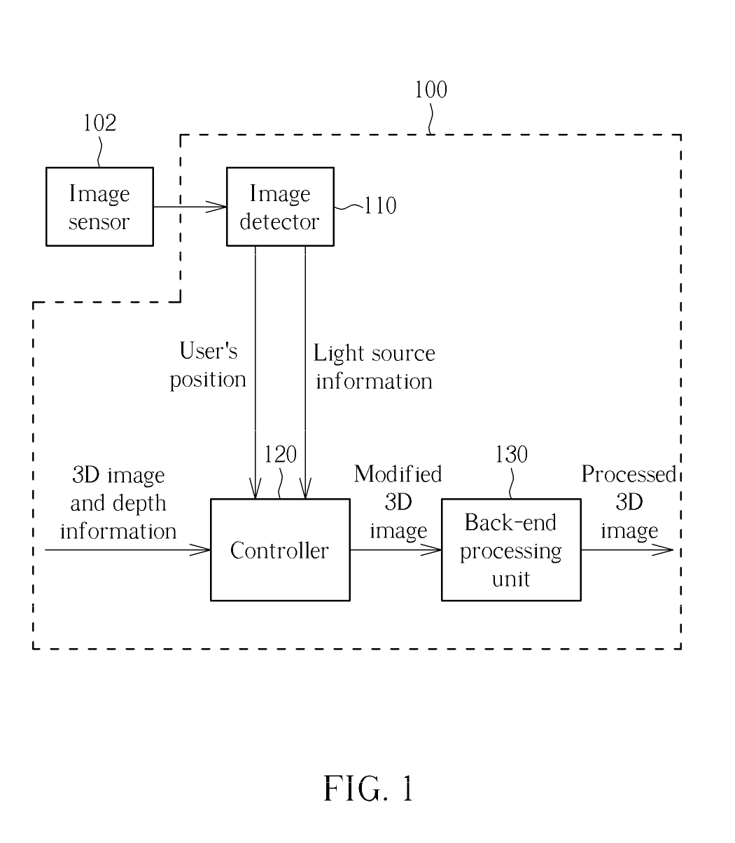

Please refer to FIG. 1, which illustrates an image processing apparatus 100 according to one embodiment of the present invention. As shown in FIG. 1, the image processing apparatus 100 includes an image detector 110, a controller 120 and a back-end processing unit 130, where the image detector 110 is coupled to an image sensor 102. In this embodiment, the image processing apparatus 100 can be built in a 3D television (TV), a notebook having a 3D screen and any other 3D display.

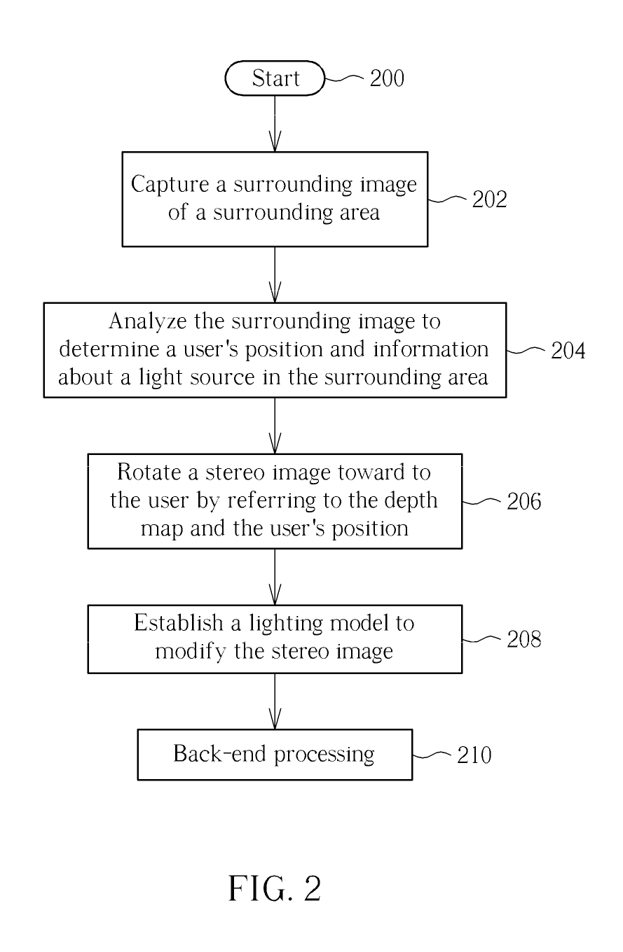

Please refer to FIGS. 1 and 2 together. FIG. 2 is a flowchart of an image processing method according to one embodiment of the present invention. It is noted that, provided that the results are substantially the same, the steps are not limited to be executed according to the exact order shown in FIG. 2. Referring to FIG. 2, the flow is described as follows.

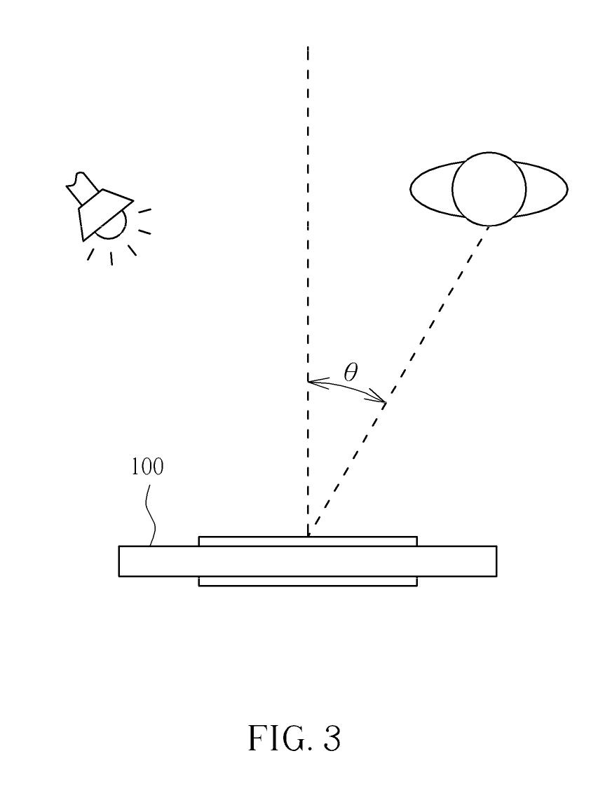

In Step 200, the flow starts. In Step 202, the image sensor 102 captures a surrounding image of a surrounding area, and the image detector 110 receives this surrounding image in a real-time manner. Then, in Step 204, the image detector 110 analyzes the surrounding image to determine a user's position and information about a light source in the surrounding area. Taking FIG. 3 as an example, the user's position can be represented by an angle 0, and the information about the light source may include a position of the light source (i.e. a height of the light source, a distance between the light source and the image sensor 102) and/or an intensity of the light source etc. As the light source detection and the user's position detection can be implemented by many well-known methods, further descriptions are omitted here.

In Step 206, the controller 120 receives a stereo image and its depth map, and rotates the stereo image towards the user by referring to the depth map and the user's position. The controller rotates the whole stereo image by the angle θ shown in FIG. 3 to generate a modified stereo image so as to make the user experience the stereo image as if the user were sitting directly in front of the television. In addition, in this embodiment, the above-mentioned rotating operation can be implemented by an Open Graphics Library (openGL) code, but this is not meant to be a limitation of the present invention.

In Step 208, the controller 120 further establishes a lighting model to modify the stereo image so that the modified stereo image shows an interaction between light and objects in the stereo image, where the lighting model is established by the position/intensity of the light source detected by the image detector 110. The objects in the stereo image are modified as if the objects were illuminated by the light model so as to eliminate or enhance the influence of the environmental light source. In addition, in this embodiment, the above-mentioned modifying operation can be implemented by an openGL code, but this is not meant to be a limitation of the present invention.

Finally, in Step 210, the back-end processing unit 130 performs other (required) image processing upon the modified stereo image, and sends the processed stereo image to a display to be displayed thereon.

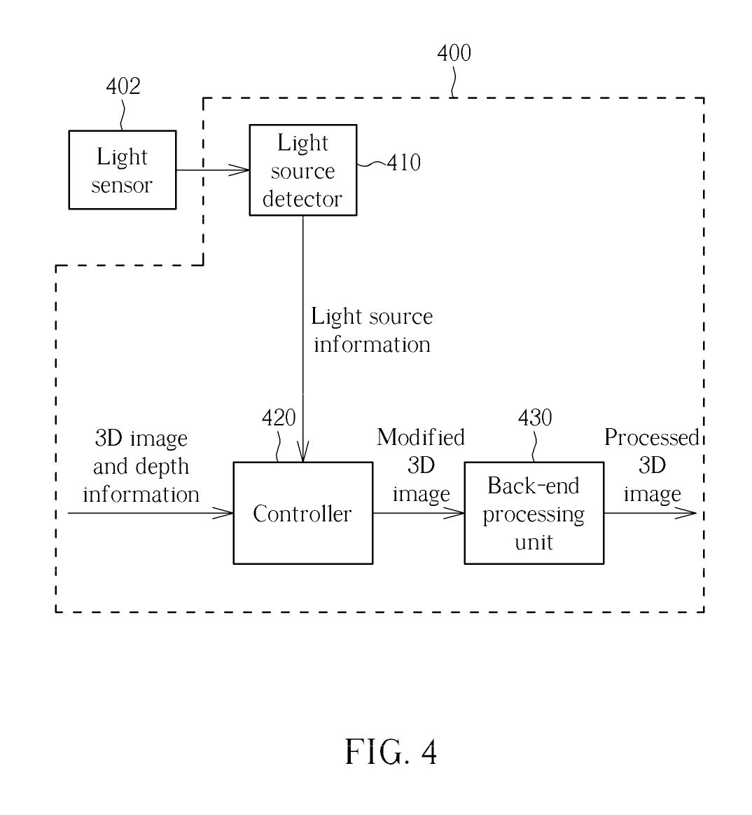

Please refer to FIG. 4, which illustrates an image processing apparatus 400 according to another embodiment of the present invention. As shown in FIG. 4, the image processing apparatus 400 includes a light source detector 410, a controller 420 and a back-end processing unit 430, where the light source detector 410 is coupled to at least one light sensor 402. In this embodiment, the image processing apparatus 400 can be built in a 3D TV, a notebook having 3D screen and any other 3D display.

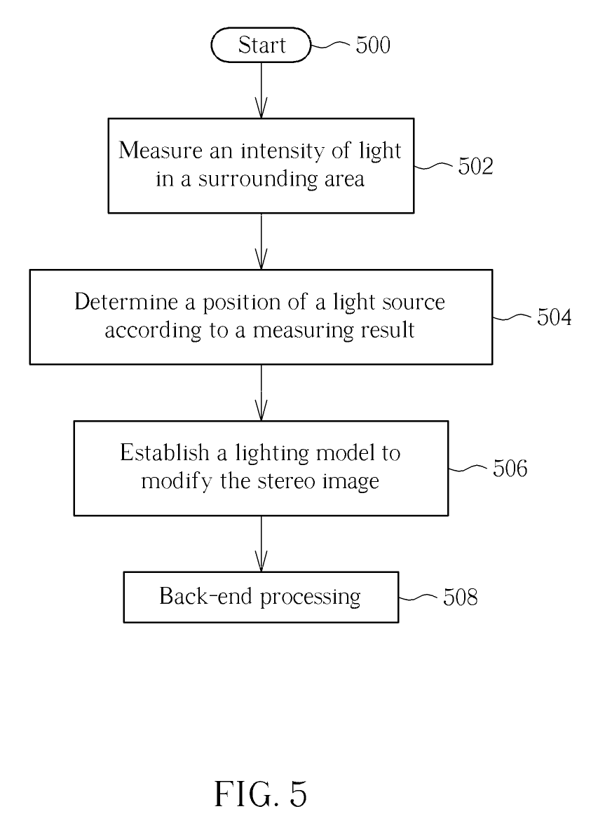

Please refer to FIGS. 4 and 5 together. FIG. 5 is a flowchart of an image processing method according to another embodiment of the present invention. Referring to FIG. 5, the flow is described as follows.

In Step 500, the flow starts. In Step 502, the light sensor 402 measures an intensity of light in a surrounding area to generate a measuring result in a real-time manner. Then, in Step 504, the light source detector 410 determines a position of a light source according to the measuring result. As the light source detection can be implemented by many well-known methods, further descriptions are omitted here.

In Step 506, the controller 420 further establishes a lighting model to modify the stereo image so that the modified stereo image shows an interaction between light and objects in the stereo image, where the lighting model is established by the position/intensity of the light source detected by the light source detector 410. The objects in the stereo image are modified as if the objects were illuminated by the light model so as to eliminate or enhance the influence caused by the environmental light source. In addition, in this embodiment, the above-mentioned modifying operation can be implemented by an openGL code, but this is not meant to be a limitation of the present invention.

Finally, in Step 508, the back-end processing unit 430 performs other (required) image processing upon the modified stereo image, and sends the processed stereo image to a display to be displayed thereon.

Briefly summarized, in the image processing apparatus and associated method of the present invention, the stereo image can be rotated/lighted according to a user's position and the light source information in the surrounding area. Therefore, the 3D images viewed by the user will appear to be of a higher viewing quality.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image processing apparatus, comprising:
an image detector, for receiving a surrounding image, and analyzing the surrounding image to determine a user's position; and
a controller, coupled to the image detector, for receiving a stereo image, and modifying the stereo image to generate a modified stereo image by at least rotating the stereo image according to the user's position.

2. The image processing apparatus of claim 1, wherein the controller receives the stereo image and its depth map, and rotates the stereo image towards the user by referring to the depth map and the user's position.

3. The image processing apparatus of claim 1, wherein the image detector further analyzes the surrounding image to determine information about a light source in a surrounding area, and the controller further modifies the stereo image according to the information about the light source in the surrounding area.

4. The image processing apparatus of claim 3, wherein the information about the light source in the surrounding area comprises information about a position of the light source, and the controller establishes a lighting model to modify the stereo image to make the modified stereo image show an interaction between light and objects in the stereo image.

5. An image processing method, comprising:
receiving a surrounding image, and analyzing the surrounding image to determine a user's position; and
receiving a stereo image, and modifying the stereo image to generate a modified stereo image by at least rotating the stereo image according to the user's position.

6. The image processing method of claim 5, wherein the step of receiving the stereo image, and modifying the stereo image to generate a modified stereo image comprises:
receiving the stereo image and its depth map, and rotating the stereo image towards the user by referring to the depth map and the user's position.

7. The image processing method of claim 5, further comprising:
analyzing the surrounding image to determine information about a light source in a surrounding area; and
modifying the stereo image according to the information about the light source in the surrounding area.

8. The image processing method of claim 7, wherein the information about the light source in the surrounding area comprises information about a position of the light source, and the step of modifying the stereo image to generate the modified stereo image according to the information about the light source in the surrounding area comprises:
establishing a lighting model to modify the stereo image to make the modified stereo image show an interaction between light and objects in the stereo image.

9. An image processing apparatus, comprising:
a light source detector, for receiving a measuring result from at least one light sensor, and determining a position of a light source according to the measuring result; and
a controller, coupled to the image detector, for receiving a stereo image and modifying the stereo image to generate a modified stereo image according to the position of the light source.

10. The image processing apparatus of claim 9, wherein the controller establishes a lighting model to modify the stereo image to make the modified stereo image show an interaction between light and objects in the stereo image.
